(19) United States
(12) Patent Application Publication
(10) Pub. No.: US 2018/0027788 A1
(43) Pub. Date: Feb. 1, 2018

(54) Fishing Rod

(71) Applicant: Jeffrey Talley Abel, Darby, MT (US)

(72) Inventor: Jeffrey Talley Abel, Darby, MT (US)

(21) Appl. No.: 15/659,459

(22) Filed: Jul. 25, 2017

Related U.S. Application Data
(60) Provisional application No. 62/369,740, filed on Aug. 1, 2016.

(51) Int. Cl. A01K 87/02; A01K 97/08

(52) U.S. Cl. CPC A01K 87/02; A01K 97/08

(57) ABSTRACT

Representative implementations of devices and techniques provide a full-size fishing rod that may be folded for storage or travel. In the implementations, the fishing rod is comprised of multiple sections (e.g., two or more sections) coupled together with a coupling line. For example, the coupling line passes through each section, coupling the multiple sections of the fishing rod together. Ferrules may be used at an end of one or more of the sections to further support the rod when extended and to guide the sections during assembly.

### PRIORITY CLAIM AND CROSS-REFERENCE TO RELATED APPLICATION

This application claims the benefit under 35 U.S.C. §119(e)(1) of U.S. Provisional Application No. 62/369,740, filed Aug. 1, 2016, which is hereby incorporated by reference in its entirety.

### BACKGROUND

Avid fishermen enjoy travelling to new or distant locations to test their skill at untried or favorite remote fishing sites. Most often, these fishermen desire to bring their own fishing gear, including their favorite fishing rods, on these adventures. However, travelling with a full-sized fishing rod can sometimes be problematic, due to the length of the rod. The fishing rods are not easily brought onto an airplane or carried in a car or bus.

Additionally, avid fishermen often desire to bring their favorite fishing rods along with them when they travel for other reasons (business, etc.), in case some spare time allows for their favorite pastime. Again, however, this is not always possible or practical, and depends on whether the mode of transportation can accommodate a full-sized fishing rod (which is generally not the case). Further, protecting their favorite fishing rod from damage or loss during travel is of great importance as well. Thus, many fishermen would rather not place their favorite rods in the care of others, such as airline baggage handlers, even temporarily.

Accordingly, some collapsible fishing rods are available as travel fishing rods. Many of these rods are telescoping, and are able to expand to a more desirable length from a fairly compact travel size. However, the telescoping travel rods generally do not have nearly the same feel or action as a standard full-size fishing rod. Additionally, the telescoping rods may not hold their length when in use, and can collapse when it is not desirable for them to do so. Other travel rods include rods with multiple rod sections, where the multiple sections are fitted together, generally by friction, to form a standard size rod. While these rods may be a closer approximation to a standard full-sized rod, they can also have their short-comings. For instance, one or more sections of the rod may come apart, and fly into the lake or river during casting or other vigorous movements. Unfortunately, this can occur more frequently as the rod sections loosen with continued travel use.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

For this discussion, the devices and systems illustrated in the figures are shown as having a multiplicity of components. Various implementations of devices and/or systems, as described herein, may include fewer components and remain within the scope of the disclosure. Alternately, other implementations of devices and/or systems may include additional components, or various combinations of the described components, and remain within the scope of the disclosure. Shapes and/or dimensions shown in the illustrations of the figures are for example, and other shapes and or dimensions may be used and remain within the scope of the disclosure, unless specified otherwise.

FIG. 1 shows an example fishing rod, in a partly folded configuration, according to an embodiment.

FIG. 2 shows the example fishing rod of FIG. 1, in an extended configuration, according to an embodiment.

FIG. 3 shows a coupling line attached to a leader line, according to an embodiment.

FIG. 4 shows an example handle portion of a fishing rod, according to an embodiment.

FIG. 5 shows a partially open end cap of a handle portion, according to an embodiment.

FIG. 6 shows an open end cap of the handle portion of FIG. 5, according to the embodiment.

FIG. 7 shows an exploded view of a top section of a fishing rod, according to an embodiment.

FIG. 8 shows an example fishing rod within a rod sock, according to an embodiment.

FIG. 9 is a flow diagram illustrating an example process for forming a fishing rod, according to an implementation.

### DETAILED DESCRIPTION

### Overview

Representative implementations of devices and techniques provide a full-size fishing rod that may be folded for storage or travel. In the implementations, the fishing rod is comprised of multiple sections (e.g., two or more sections) coupled together with a coupling line. For example, the coupling line passes through each section, coupling the multiple sections of the fishing rod together. Ferrules may be used at an end of one or more of the sections to further support the rod when extended and to guide the sections during assembly.

In various implementations, the sections may be any suitable length that is convenient or desirable for storage or travel (such as a length that fits easily within an overhead storage bin of a commercial aircraft, for example), and may be extended to form a sturdy fishing rod that has a standard or desirable length and size. In one example embodiment, the rod sections are approximately 19″ long, and with six sections, they extend to form a fishing rod that is about 9.5′ long. In other embodiments, any number of rod sections may have any length, and may extend to form a fishing rod of any desired length.

In an implementation, the coupling line is comprised of an elastic material. The elastic material applies a tension throughout the multiple sections so that the sections do not separate during casting with the extended rod. The elastic material also allows the rod to be easily extended from a folded configuration (e.g., just flick the rod out).

In another implementation, a non-elastic leader line is fixed to an end of the coupling line. The leader line is much easier to thread through the multiple rod sections, particularly the top-end sections, which have an extremely small cross-sectional diameter. Additionally, the leader line may comprise a non-elastic material arranged to avoid bending while being threaded through the rod sections. Once the leader line is threaded through the rod sections, the coupling line may be pulled through the rod sections using the leader line. In an embodiment, the leader line is removeably coupled to the top-most rod section and the coupling line is tied to the leader line within one of the rod sections.

The fishing rod assembly includes features which allow the user to repair or replace portions of the rod more quickly and efficiently. For instance, the coupling line is threaded through all of the sections of the rod, including the butt-end of the rod. In an embodiment, the butt-end of the rod (or another portion of the rod) has a removable cap that allows quick access to the coupling line. With the easy access to the coupling line, damaged sections of the rod are easily removed from the coupling line and replaced, or the coupling line itself may be easily replaced if desired.

Additional features and benefits of the fishing rod assembly will be apparent to persons having skill in the art, as well as to those familiar with the disadvantages of other multi-piece fishing rods. For example, the disclosed fishing rod may be used as a fly fishing rod, as well as a bass fishing rod, or other type of fishing rod. Because of the coupling line running through the rod sections, and the tension applied by the coupling line, there is no opportunity for a rod section to fly off during casting with the fishing rod (which tends to be problem with other sectioned fishing rods, particularly as the quantity of sections increases). Further, the fishing rod remains flexible and durable throughout the length of the fishing rod, not unlike a single piece fishing rod, despite being comprised of multiple sections.

Various implementations of devices and techniques for a fishing rod are discussed in this disclosure. The devices and techniques are discussed with reference to example implementations illustrated in the figures. The devices and techniques discussed herein are referred to in the environment of a fishing rod for ease of discussion and illustrative convenience. The devices and/or techniques may also be used in other environments, with other implementations, and associated with other components or systems, and the like, to provide an extendable or foldable rod for any imaginable use.

Implementations are explained in more detail below using a plurality of examples. Although various implementations and examples are discussed here and below, further implementations and examples may be possible by combining the features and elements of individual implementations and examples.

### Example Embodiments

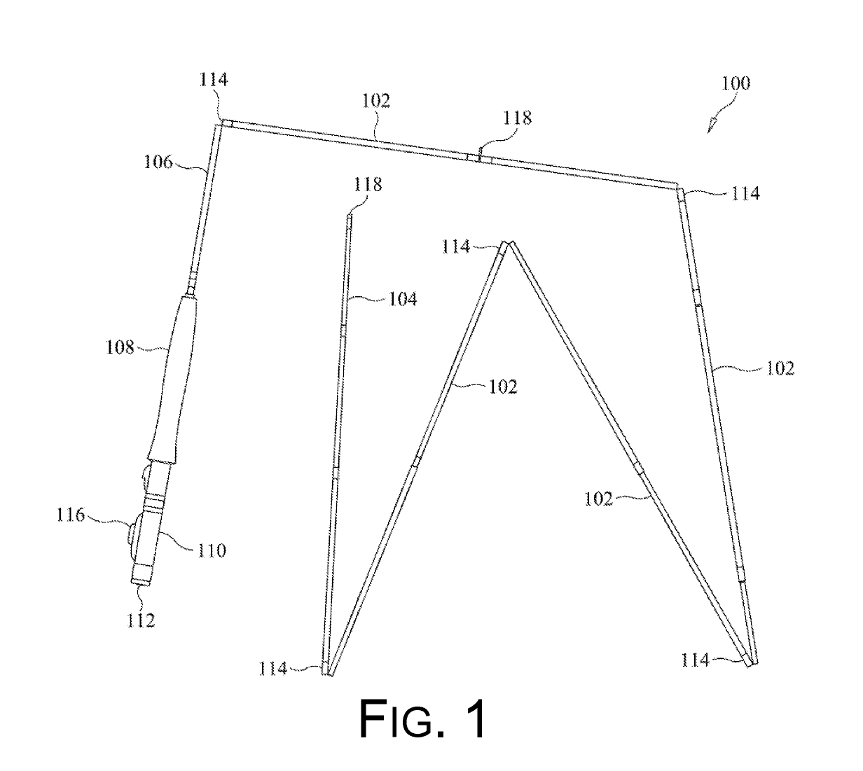

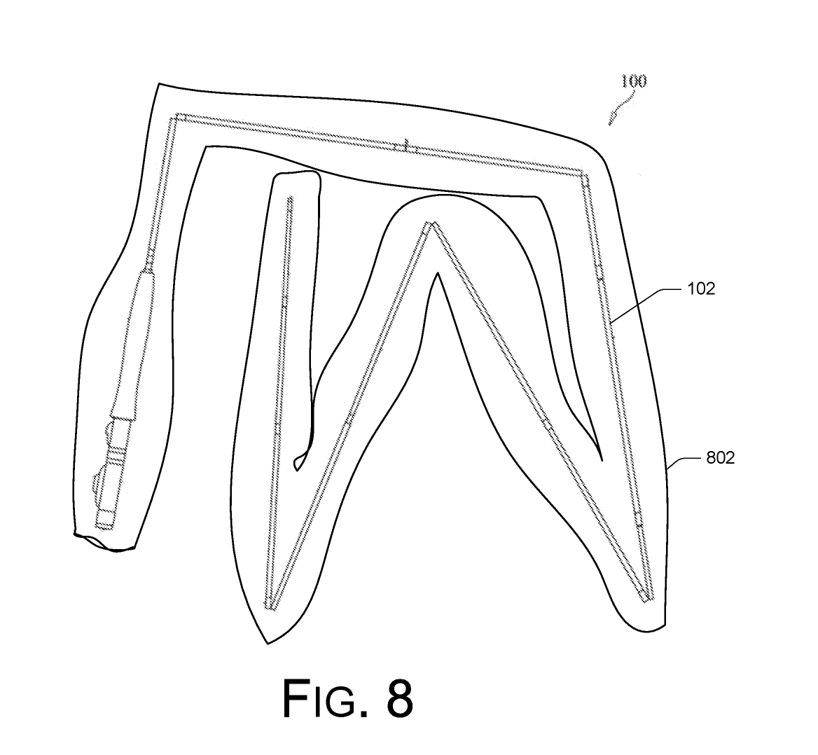

Referring to FIGS. 1-8, in various implementations, a fishing rod assembly 100 is shown in several non-limiting example configurations. In the implementations, a fishing rod assembly 100 includes a plurality of rod sections 102, including a top section 104 and a bottom section 106; and a handle portion 108, which includes a butt-end 110. The butt-end 110 may have a removable end cap 112 which provides access to a coupling line 302 that runs through each of the rod sections 102 (including the top section 104 and the bottom section 106).

In an implementation, the fishing rod 100 includes a ferrule 114 coupled to at least one end of one or more of the rod sections 102. In the implementation, the ferrule 114 is arranged to align adjacent rod sections 102 when the rod sections 102 are coupled together in the extended configuration and to guide the rod sections 102 during assembly. In some embodiments, the butt-end 110 includes a reel seat 116 for attaching a fishing reel (not shown) to the fishing rod 100. In various implementations, some or all of the rod sections 102 include a line guide or eye 118 for guiding the fishing line (not shown) along a length of the fishing rod 100.

In some embodiments, the fishing rod 100 includes additional or alternate components. Further, some examples of components of a fishing rod 100 may have a different shape, size, or design than as illustrated in FIGS. 1-7. For example, a fishing rod 100 may be comprised of fewer or a greater quantity of sections 102, which may have different lengths, cross-sectional shapes or diameters, and so forth.

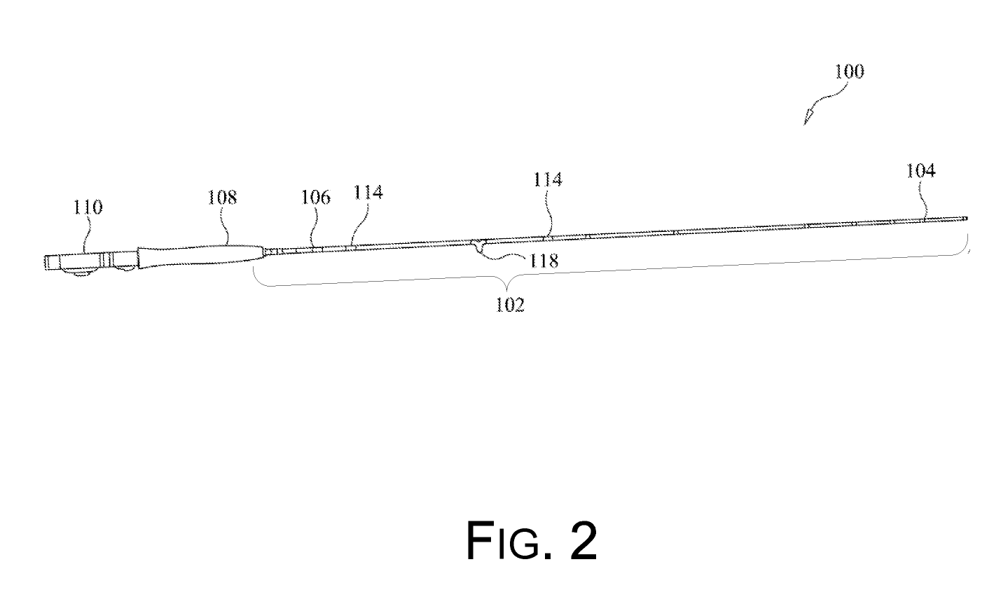

In various implementations, as shown in FIGS. 1 and 2, the fishing rod 100 is shown comprised of a plurality of hollow or partially hollow rod sections 102, including a top section 104 and a bottom section 106. The rod sections 102 (including the top section 104 and the bottom section 106) may be coupled together to form a unified continuous rod 100 when in a first “extended” configuration (as shown in FIG. 2) or may be folded one over another when in a second “folded” configuration (as shown in FIG. 1). In various embodiments, the rod sections 102 may be comprised of graphite, fiberglass, high modulus graphite fiber or carbon fiber, bamboo, or the like, and may be hollow or partially hollow to accommodate the coupling line 302 passing through the rod sections 102.

In an implementation, the rod sections 102 are coupled together using a single continuous coupling line 302. The coupling line 302, comprising a cord, thread, string, wire, etc., keeps the rod sections 102 together and in a desired order, and allows the rod sections 102 to fold between each of the rod sections 102 (where the coupling line 302 acts like a flexible joint, for instance).

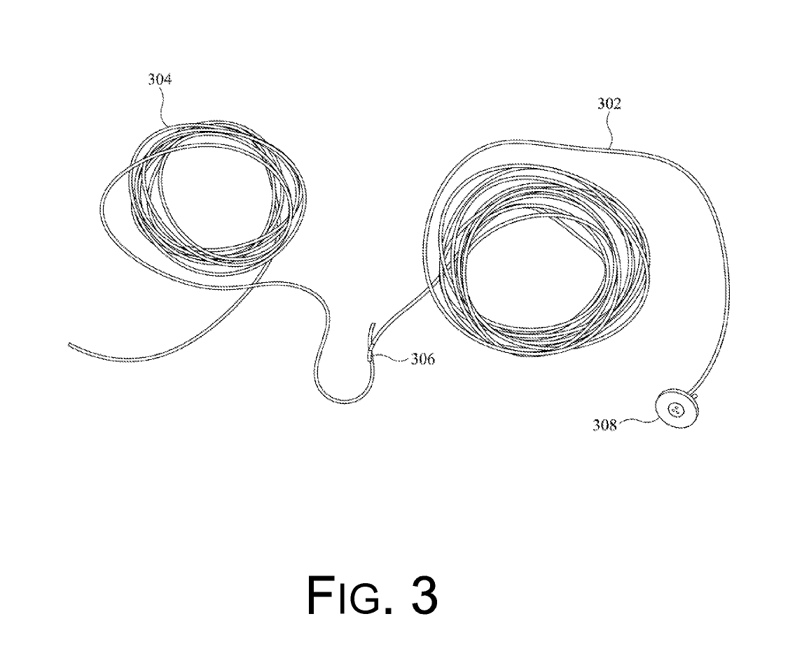

An example coupling line 302 is shown in FIG. 3. The coupling line 302 is threaded through each of the rod sections 102 and through the handle portion 108 (including the butt-end 110), and is coupled to the top section 104 and to the handle portion 108. The coupling line 302 is arranged to apply a tension to each of the rod sections 102 (including the top section 104 and the bottom section 106) while the rod sections 102 are coupled together in the extended configuration. The tension pulls each of the rod sections 102 toward each other to retain the rod sections 102 in the extended configuration during use of the fishing rod 100. For instance, the tension is applied to all of the rod sections 102 so that the rod sections 102 do not separate during casting with the fishing rod 100.

The tension applied by the coupling line 302 is also useful when extending the fishing rod 100 from the folded configuration. Due to the tension, flicking the rod 100 outwardly allows the rod sections 102 to align and to come together in the extended configuration. In some cases, the ferrules 114 help to guide the rod sections 102 as they come together during extension.

The coupling line 302 may be comprised of a single layer of material or multiple layers or strands of material for strength and durability. At least one layer may be an elastic material, such as a natural or synthetic rubber, or the like, to provide the tension desired. For instance, the coupling line 302 is installed within the rod sections 102 under tension (by stretching the coupling line 302, etc.). Other layers may include elastic materials or non-elastic materials, such as polyesters, for instance, to provide low friction for the coupling line 302 within the rod sections 102.

In an alternate implementation, the coupling line 302 may be a non-elastic material. In the alternate implementation, the coupling line 302 may be attached to a tensioning device (such as a spring mechanism, or the like) located in the butt-end 110 of the handle portion 108, for example (not shown). In alternate implementations, the coupling line 302 comprises multiple lines in parallel or series, where the multiple lines comprise the same or different materials selected for the properties of the lines.

As shown in FIG. 3, the coupling line 302 may be tied to a leader line 304. The leader line 304 facilitates threading the coupling line 302 through the rod sections 102. The leader line 304 may be comprised of a low-friction material such as a nylon material, or the like, and may be stiff enough to easily thread through the rod sections 102. The coupling line 302 can be pulled through the rod sections 102 by the leader line 304, as the leader line 304 is arranged to avoid bending while being threaded through the rod sections 102. In various embodiments, the leader line 304 is attached to the coupling line 302 via a knot 306, such as a barrel knot, or the like.

In an embodiment, the leader line 304 is removeably coupled to the top section 104, while the coupling line 302 is attached to the leader line 304 within one of the sections 102, such as the top section 104. In various examples, the top section 104 has an extremely small cross-sectional diameter. In these examples, the leader line 304 is sized to be able to pass through a very small channel through the top section 104. For instance, it may be unlikely for the coupling line 302 to pass through the top section 104, due to the greater diameter of the coupling line 302 (particularly if the coupling line 302 is comprised of multiple layers).

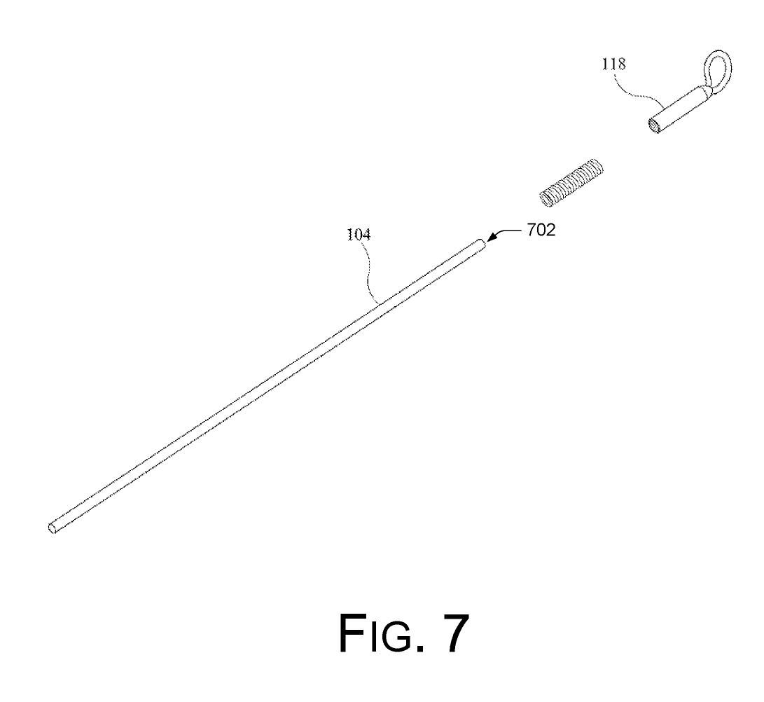

Referring to FIG. 7, the leader line 304 (not shown) may be coupled to the top section 104 by running the leader line 304 out a hole 702 at the top-end of the top section 104 (while the coupling line 302 is pulled to create a desired tension). The leader line 304 can be bent over the top-end of the top section 104, and held in place (via friction, adhesive, etc.), by sliding the line guide 118 over the bent-over portion of the leader line 304, for instance.

In another implementation, as shown in FIG. 7, the leader line 304 can be passed through a hollow (or partially hollow) threaded barrel connector 704, which can be coupled to the terminal end (i.e., the topmost end) of the top section 104 via friction, adhesive, etc. The leader line 304 can be bent over the barrel connector 704, and the top-end line guide 118 can be screwed onto the barrel connector 704. For example, the line guide 118 is arranged to trap the coupling line 302 or a leader line 304 coupled to the coupling line 302 between the barrel connector 704 and the line guide 118 when the line guide 118 is screwed onto the barrel connector 704. This holds the leader line 304 in place, as well as coupling the top-end line guide 118 to the top section 104. Additionally, this allows the leader line 304 and coupling line 302 to be easily accessed for replacement or repair. For example, to replace or repair the coupling line 302 or one of the sections 104, the top-end line guide 118 can be unscrewed from the barrel connector 704, releasing the leader line 304.

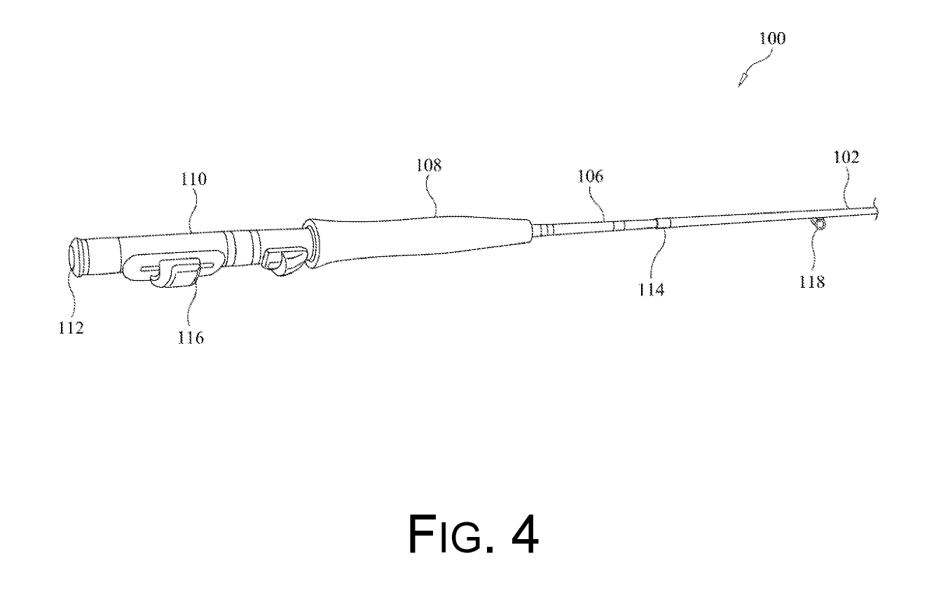

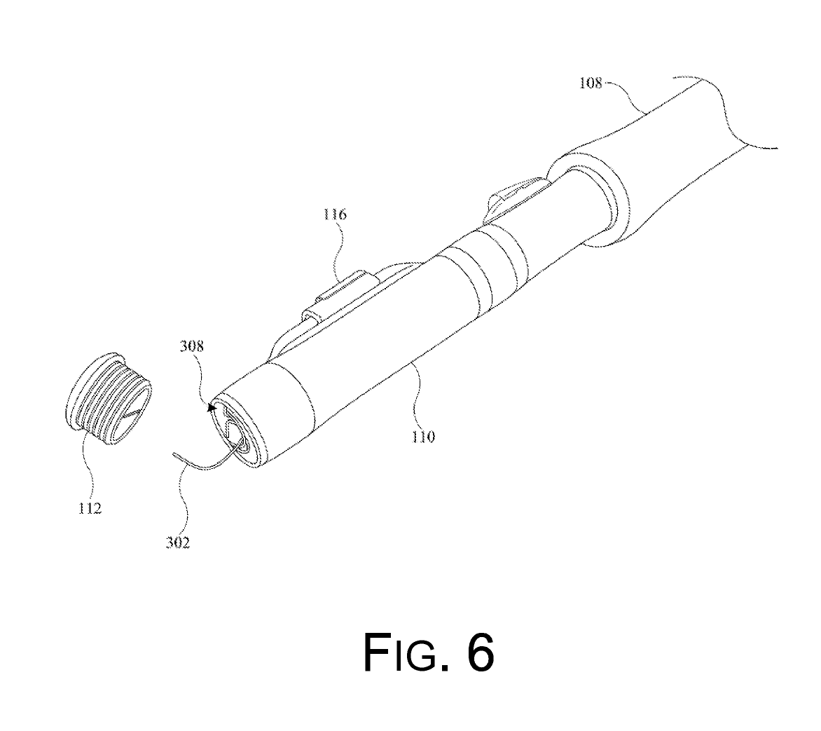

As shown in FIGS. 4-6, the fishing rod 100 can include a handle portion 108 coupled to or integral to an end of the bottom (or last) section 104. In an example, the handle portion 108 is arranged to be gripped by a user during use of the fishing rod 100 while the rod 100 is in the extended configuration. In an embodiment, the opposite end of the coupling line 302 is threaded through the handle portion 108 and is removeably coupled to the butt-end 110 of the handle portion 108. In one implementation, an anchor 308 (such as a button, clip, or other object) may be fastened to the coupling line 302, so as to engage (e.g., be captured by) one or more features of the butt-end 110. This is illustrated in FIG. 6, where the tension of the coupling line 302 holds the anchor 308 in place against one or more features of the butt-end 110.

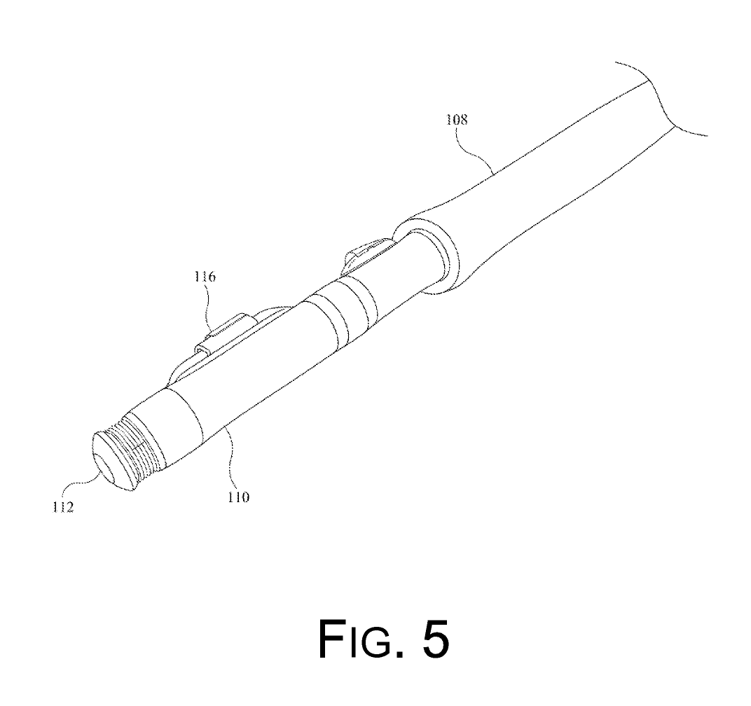

As shown in FIGS. 4-6, in various embodiments, the butt-end 110 of the handle portion 108 includes a removable end cap 112 that allows access to the coupling line 302 by a user. As shown in FIGS. 5 and 6, the cap may be threaded, or otherwise include features (e.g., twist lock, bayonet, snap fit, etc.) allowing removal and replacement of the end cap 112. Easy access to the coupling line 302 allows for easy replacement of one or more of the rod sections 102, or replacement of the entire coupling line 302, if desired. For instance, once the coupling line 302 is disengaged from the butt-end 110, one or more of the rod sections 102 may be slid off of the coupling line 302. The leader line 304 may be removed from the top section 104, if desired.

To assemble the fishing rod 100, a leader line 304 is tied to a coupling line 302, which has an anchor 308 attached to an opposite end. (In an implementation, the leader line 304, coupling line 302, and anchor 308 may be provided as a pre-prepared assembly for repairing the fishing rod 100.) The leader line 304 is threaded through each of the rod sections 102 in order, pulling the coupling line 302 behind it. The anchor 308 is seated within the butt-end 100 and the coupling line 302 is stretched (by pulling the leader line 304) to be under desired tension. The leader line 304 is fastened to the top section 104 as described above, using the line guide 118 at the end of the top section 104.

In an embodiment, the fishing rod 100 includes a protective sock 802 for storage or transportation of the fishing rod 100. For instance, the rod sock 802 can have a length approximately equal to a length of the fishing rod 100 while in the extended configuration. Additionally, the rod sock 802 is arranged to be folded with the rod sections 102 while the fishing rod 100 is in the folded configuration. For example, the fishing rod 100 is inserted into the rod sock 802 while extended, and then the rod sections 102 are separated and folded while in the rod sock 802.

The examples shown in FIGS. 1-8 and described herein are not intended to be limiting, and are for ease of discussion and illustrative convenience. Although various implementations and examples are discussed herein, further implementations and examples may be possible by combining the features and elements of individual implementations and examples. In alternate implementations, the fishing rod 100 may have other arrangements or configurations, and may be used with additional components and so forth.

In various implementations, additional or alternative components, techniques, sequences, or processes may be used to implement the techniques described herein. The components and/or techniques may be arranged and/or combined in various combinations, while resulting in similar or approximately identical results. It is to be understood that a fishing rod 100 may be implemented as a stand-alone device or as part of a system (e.g., integrated with other components).

### Representative Process

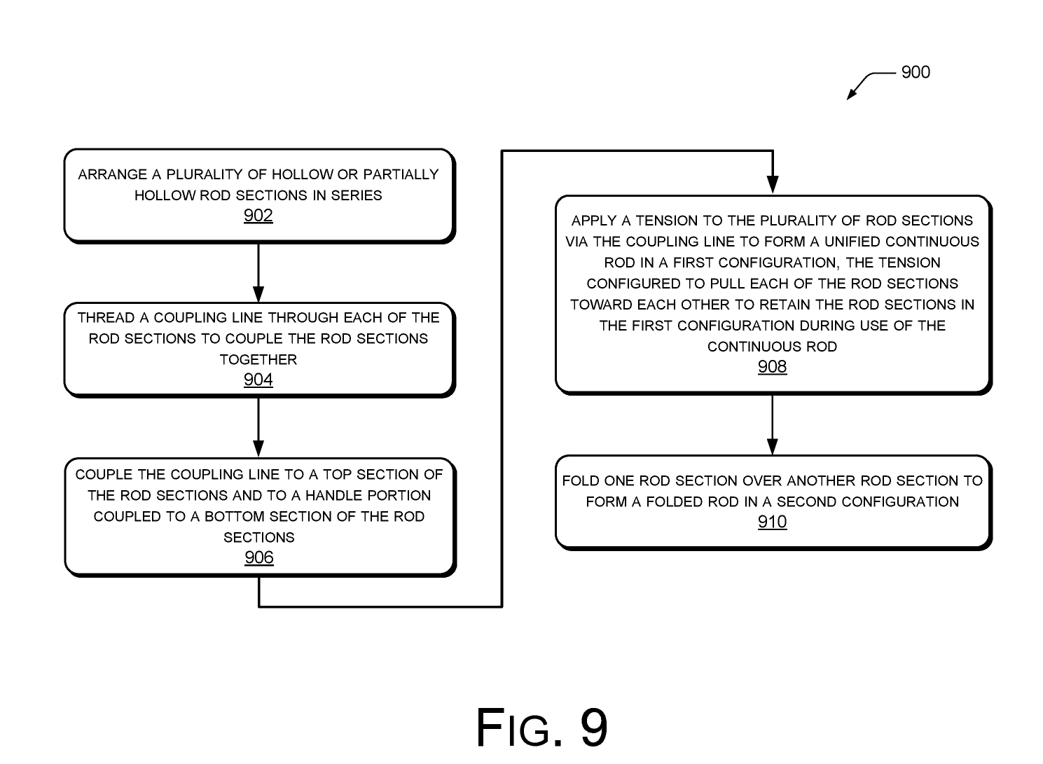

FIG. 9 illustrates a representative process 900 for implementing techniques and/or devices relative to a foldable or expandable fishing rod (such as fishing rod 100, for example). The process 900 includes threading a line or cord through a plurality of rod sections, where the line or cord retains the rod sections together. The example process 900 is described with reference to FIGS. 1-8.

The order in which the process is described is not intended to be construed as a limitation, and any number of the described process blocks can be combined in any order to implement the process, or alternate processes. Additionally, individual blocks may be deleted from the process without departing from the spirit and scope of the subject matter described herein. Furthermore, the process can be implemented in any suitable hardware, software, firmware, or a combination thereof, without departing from the scope of the subject matter described herein.

At block 902, the process includes arranging a plurality of hollow or partially hollow rod sections (such as rod sections 104, for example) in series.

At block 904, the process includes threading a coupling line (such as coupling line 302, for example) through each of the rod sections to couple the rod sections together. In an implementation, the process includes coupling a leader line to the coupling line to facilitate threading the coupling line through each of the rod sections.

At block 906, the process includes coupling the coupling line to a top section of the rod sections and to a handle portion (such as handle portion 108, for example) coupled to a bottom section of the rod sections. In an implementation, the process includes coupling the leader line to the top section via a line guide coupled to a terminal end of the top section.

In an implementation, the process includes coupling a barrel connector to a terminal end of the top section and removeably coupling a line guide to the barrel connector to removeably couple the coupling line to the top section.

At block 908, the process includes applying a tension to the plurality of rod sections via the coupling line to form a unified continuous rod in a first configuration. The tension is configured to pull each of the rod sections toward each other to retain the rod sections in the first configuration during use of the continuous rod (such as when fishing with the rod, for example). In an implementation, the process includes coupling a ferrule to at least one end of one or more of the rod sections and aligning adjacent rod sections via the ferrule when the rod sections are assembled into the first configuration, wherein adjacent ends of the adjacent rod sections are arranged to fit snugly within the ferrule.

At block 910, the process includes folding one rod section over another rod section to form a folded rod in a second configuration. The folded second configuration is useful for travel or when storing of the rod. In many implementations, the folded configuration is less than 20 inches long. In alternate implementations, the folded configuration is greater or equal to 20 inches long, but significantly shorter than the rod in the first configuration.

In an implementation, the process includes removing an end cap from the handle portion and accessing the coupling line from the handle portion to remove the coupling line or one or more of the rod sections. For example, the coupling line or one or more of the rod sections may be removed for repair, for replacement, or the like.

In alternate implementations, other techniques may be included in the process in various combinations, and remain within the scope of the disclosure.

### CONCLUSION

While various discreet embodiments have been described throughout, the individual features of the various embodiments may be combined to form other embodiments not specifically described. The embodiments formed by combining the features of described embodiments are also within the scope of the disclosure.

What is claimed is:

1. A fishing rod, comprising:
a plurality of hollow or partially hollow rod sections, including a top section and a bottom section, the rod sections arranged to be coupled together to form a unified continuous rod when in a first configuration or to be folded one over another when in a second configuration; and
a coupling line threaded through each of the rod sections, the coupling line coupled to the top section, the coupling line arranged to apply a tension to the plurality of rod sections while the rod sections are coupled together in the first configuration, the tension configured to pull each of the rod sections toward each other to retain the rod sections in the first configuration during use of the fishing rod.

2. The fishing rod of claim 1, further comprising a handle portion coupled to or integral to an end of the bottom section, the handle portion arranged to be gripped by a user during use of the fishing rod while in the first configuration.

3. The fishing rod of claim 2, wherein the coupling line is threaded through the handle portion and is removeably coupled to the handle portion.

4. The fishing rod of claim 3, further comprising an anchor device coupled to the coupling line and configured to engage one or more features of the handle portion to removeably couple the coupling line to the handle portion.

5. The fishing rod of claim 2, further comprising a removable end cap coupled to the handle portion and arranged to allow user access to the coupling line within the handle portion.

6. The fishing rod of claim 1, further comprising a hollow or partially hollow barrel connector coupled to a terminal end of the top section, the barrel connector arranged to removeably couple the coupling line to the top section.

7. The fishing rod of claim 6, further comprising a line guide removeably coupled to the barrel connector and arranged to removeably couple the coupling line to the barrel connector.

8. The fishing rod of claim 7, wherein the barrel connector includes screw threads on an outside surface of the barrel connector and the line guide includes screw threads on an inside surface of the line guide, and wherein the line guide is arranged to trap the coupling line or a leader line coupled to the coupling line between the barrel connector and the line guide when the line guide is screwed onto the barrel connector.

9. The fishing rod of claim 1, further comprising a ferrule coupled to at least one end of one or more of the rod sections, the ferrule arranged to align adjacent rod sections when the rod sections are being assembled into the first configuration and when the rod sections are coupled together in the first configuration.

10. The fishing rod of claim 1, further comprising a leader line coupled to an end of the coupling line, the leader line arranged to facilitate threading the coupling line through the rod sections.

11. The fishing rod of claim 10, wherein the leader line is arranged to couple the coupling line to the top section.

12. The fishing rod of claim 10, wherein the leader line comprises a non-elastic material arranged to avoid bending while being threaded through the rod sections.

13. The fishing rod of claim 1, wherein the coupling line comprises an elastic material.

14. The fishing rod of claim 1, wherein the coupling line comprises a plurality of layers or strands of same or different materials.

15. The fishing rod of claim 1, further comprising a rod sock arranged to protect the fishing rod during storage or transportation, the rod sock having a length approximately equal to a length of the fishing rod while in the first configuration, the rod sock is arranged to be folded with the rod sections while the fishing rod is in the second configuration.

16. A method, comprising:
arranging a plurality of hollow or partially hollow rod sections in series;
threading a coupling line through each of the rod sections to couple the rod sections together;
coupling the coupling line to a top section of the rod sections and to a handle portion coupled to a bottom section of the rod sections;
applying a tension to the plurality of rod sections via the coupling line to form a unified continuous rod in a first configuration, the tension configured to pull each of the rod sections toward each other to retain the rod sections in the first configuration during use of the continuous rod; and
folding one rod section over another rod section to form a folded rod in a second configuration.

17. The method of claim 16, further comprising coupling a ferrule to at least one end of one or more of the rod sections and aligning adjacent rod sections via the ferrule when the rod sections are assembled into the first configuration, wherein adjacent ends of the adjacent rod sections are arranged to fit snugly within the ferrule.

18. The method of claim 16, further comprising coupling a leader line to the coupling line to facilitate threading the coupling line through each of the rod sections, and coupling the leader line to the top section via a line guide coupled to a terminal end of the top section.

19. The method of claim 16, further comprising coupling a barrel connector to a terminal end of the top section and removeably coupling a line guide to the barrel connector to removeably couple the coupling line to the top section.

20. The method of claim 16, further comprising removing an end cap from the handle portion and accessing the coupling line from the handle portion to remove the coupling line or one or more of the rod sections.
